(19) United States
(12) Patent Application Publication
(10) Pub. No.: US 2024/0186026 A1
(43) Pub. Date: Jun. 6, 2024

(54) Artificial Electromagnetic Field Array for Particle Fusion, Confinement

(71) Applicants: Olatunbosun Osinaike, Pleasant Prairie, WI (US); Olatunde Osinaike, Atlanta, GA (US); Olajuwon Osinaike, Denver, CO (US); Peter Patterson, Mount Pleasant, WI (US)

(72) Inventors: Olatunbosun Osinaike, Pleasant Prairie, WI (US); Olatunde Osinaike, Atlanta, GA (US); Olajuwon Osinaike, Denver, CO (US); Peter Patterson, Mount Pleasant, WI (US)

(21) Appl. No.: 18/074,469

(22) Filed: Dec. 3, 2022

(51) Int. Cl. G21B 1/23

(52) U.S. Cl. CPC G21B 1/23

(57) ABSTRACT

This invention is a process to terraform an atmosphere, and encourage quantum fusion, by creating an energy field, projecting electric field vectors onto the electromagnetic field at a gravitational system's Lagrange Points of gravitational stability. Projecting electric field vectors onto a electromagnetic field with Lagrange gravitational stability, enables fusion by encouraging quarks to combine into the desired element, whose electron shell configuration is being mimicked by the electric field vectors. It utilizes the Lagrange gravitational fields of orbital stability, as a quantum architecture on which encourage fusion.

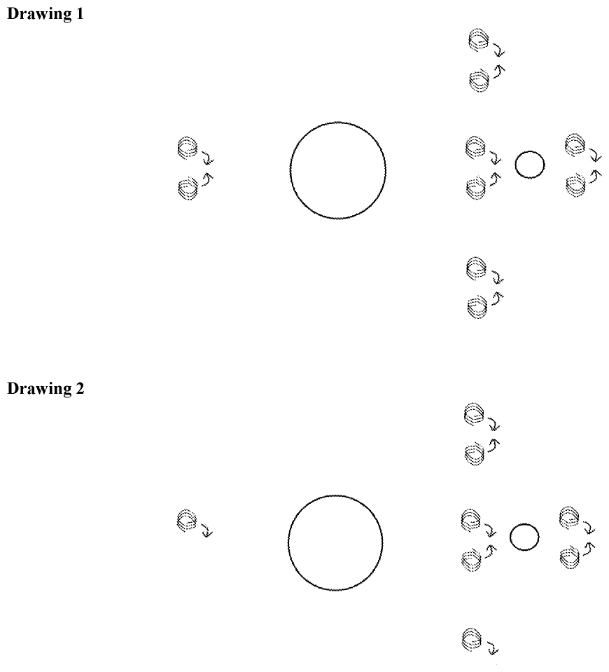

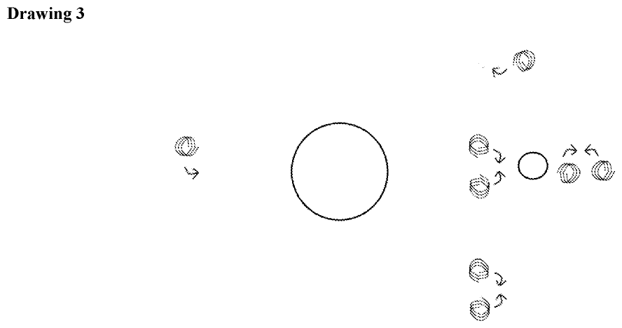

### CROSS REFERENCE TO RELATED APPLICATIONS

Provisional Application 63/286,031, Dec. 4, 2021
Provisional Application 63/288,524, Dec. 11, 2021

### BACKGROUND OF THE INVENTION

This patent application is a utility patent application in the field of electromagnetism and terraforming celestial bodies.

### BRIEF SUMMARY OF THE INVENTION

This patent application pertains to an electromagnetic field array, utilized for particle confinement, elemental fusion. This method may be applied at the Lagrange points of any two celestial bodies, along the heliospheric current sheet, or the galactic current sheet.

### BRIEF DESCRIPTION OF THE DRAWINGS

Drawing 1 is the electromagnetic array corresponding with the electron shell configuration for noble gas Neon, where there are dual pairs of opposite spin, circularly polarized electromagnetic radiation at each of the L1, L2, L3, L4, and L5 Lagrange Points to mimic opposite spin electrons within the 1s, 2s, and 2p shell orbital. The L3, L4, L5, correspond with the P group subshells.

Drawing 2 is the electron shell configuration for Oxygen, where 2 of the three Lagrange Points, L3, L4, L5, are half full, as the 2 of the 3 P subshells for Oxygen contain only one electron.

Drawing 3 also demonstrates the electron shell configuration for Oxygen, where the electromagnetic fields are aligned along different directional axes in the P shell to mimic the x, y, z orbitals for in the electron shell.

### DETAILED DESCRIPTION OF THE INVENTION

This patent application pertains to a method which creates an artificial array of electromagnetic fields, or circularly polarized projections of electromagnetic radiation, which mimic the electron shell configuration of an element, or compound comprised of elements, in order to create electromagnetic vectors within the interplanetary magnetic field, that encourage fusion of subatomic quarks into desired elements. The projection of electric field vectors at Lagrange points of co-orbital stability that mimic electron spin encourages subatomic particles in the interplanetary magnetic field to assemble into the element whose electron shell configuration is being replicated by the energy field.

To create electromagnetic vectors that mimic the opposite spins within an electron shell configuration, this process uses the projection of circularly, or linearly, polarized light to project circular electric field vectors in alignment with the Sun's electromagnetic field. This causes circular electron flow around, along and across the Sun's electromagnetic field lines, for electrons subjected to the polarized light. The circularly or linearly polarized light may be projected on opposite halves of the interplanetary magnetic field, the heliospheric current sheet, as well as other directions. A similar method may be utilized to encourage fusion along and across the galactic current sheet.

This method may further encourage the fusion into desired elements by utilizing the emission, or absorption spectrum of the desired element, compounds, such that the projection of polarized light propagates electromagnetic radiation at those specific wavelengths. Opposite spin, circularly polarized electromagnetic radiation pairs may utilize alternate configurations of absorption, emission spectrums, or the same spectrum, rotating in the same or opposite directions.

Creating an artificial array electromagnetic fields will also help increase the electron density along a region of the heliospheric current sheet, or galactic current sheet. The current sheets bend in a manner similar to a bending magnet. In the same way that a bending magnet emits photons by curving a stream of electrons, increasing the electron density in a region of the current sheet, will emit more photons, increasing the electromagnetic radiation reaching Mars, and other planets that are candidates for terraforming. This invention is not limited to using projections of polarized light, and may also place an array of electromagnetic fields at the Lagrange Points.

In coordinating the energy levels, electron shell configuration to Lagrange equivalencies, the L1 and L2 correspond with the 1s2 and 2s2 electron shells, interchangeable. The L3, L4, and L5 correspond to the P subshell, 2p1-2p6.

The L1 and L2 Lagrange Points will be utilized for the fusion of elements with 1s2, 2s2 electron shell configurations.

The L3, L4 and L5 Lagrange Points will be utilized for the P shell electrons, to encourage the fusion of elements with 1s2, 2s2, 2p1-2p6 electron shell configurations.

The electromagnetic field, electric field vectors placed at a Lagrange point may maintain a certain alignment between its electromagnetic axis, or rotational axis and the Sun's electromagnetic field, electromagnetic axis, heliospheric current sheet, or rotational axis.

Noble Gas Neon's electron shell configuration would utilize all L1, L2, L3, L4, and L5 Lagrange Points, and project two circular electric field vectors, via circularly polarized light, at each Lagrange point, mimicking the full s and p subshells in Neon's electron shell configuration.

Oxygen, having an electron shell configuration of 1s2, 2s2, 2p4, would utilize all 5 Lagrange points, whilst having only one electromagnetic projection at two of the triangular Lagrange points: L3, L4, L5; mimicking Oxygen's electron shell configuration where 2 of the 3 p subshells are half full.

Water, H2O, has a similar electron shell configuration to Neon, as the 1s2 2s2 2p6 fill of the p shell that differentiates Neon from Oxygen, would be filled by the Hydrogen 1s1 electron shell. Utilizing different absorption and emission spectrums that correspond to the specific element or compound, helps the fusion array correspond more precisely to specific element or compound when the hybrid shell configuration is similar to other elements. To encourage the formation of water, the array might mimic the electron shell configuration of Neon, filling all P orbitals, while using the absorption, emission spectrum of Hydrogen or Water for 2 of the 6 P orbitals. This is the electron shell configuration of Oxygen, combined with two electron shell configurations for Hydrogen at the half full P subshells.

Certain electron shell configurations may be desirable for their cooling properties. Neon is a refrigerant, with a 1s2, 2s2, 2p6 electron shell configuration. It has a very similar electron shell configuration to Water, which is a heat sink; Oxygen combined with 2 Hydrogens to fill the P shell.

Another element which would be useful for terraforming planets, that has an electron shell configurations in the range of 1s2, 2s2, 2p1-2p6 is Nitrogen, which comprises 78% of Earth's atmosphere.

The array of circularly polarized electromagnetic waves may be utilized for the Lagrange Points for any planet with enough mass to choreograph Lagrange gravitational orbital points through its co orbit with another celestial body. In the absence of celestial bodies with mass large enough to create Lagrange vectors, an orbital range around a Star may be utilized, where L1, L2, L3, L4, L5 coordinate a desired fusion output location.

To achieve electron shell configurations with higher shells, such as d shells, an astral coordinate system should be utilized to locate Star-Star gravitational Lagrange points which compose the combined structure of the element whose electron shell configuration is desired.

The heliospheric current sheet may be aligned parallel, perpendicular, or slightly tilted from the orientation of the artificial electromagnetic arrays placed at Lagrange Points. The electromagnetic fields, electric field vectors may rotate in such a manner to maintain the certain angular alignment with the Sun's electromagnetic field lines, heliospheric current sheet, and or galactic current sheet, as a Star's electromagnetic field is a fluid field that often changes orientation.

Opposite spin magnetic fields in the same subshell may be oriented along the same axis, and rotate around a Lagrange Point's Center by rotations that are opposite, where one magnetic field is in retrograde orbit, and the other is in prograde orbit.

The artificial electromagnetic fields that mimic the electron spin within electron shell sub-orbitals, may mimic the spin of electrons in a suborbital in additional manners.

They may arrange into a retrograde and prograde orbit around the Lagrange point, where their magnetic field axes have a certain alignment with the Sun's electromagnetic field. The magnetic fields within a suborbital shell may also have the same orbit around a Lagrange point, such that their orbits move in the same direction. The magnetic fields within a suborbital shell may have corresponding or opposite rotations. They may further have corresponding or dissimilar angular precession.

The artificial electromagnetic fields may use parallel or non parallel rotational and electromagnetic axes, where the rotation axis of the artificial electromagnetic array components are aligned with the Sun's magnetic field, but the electromagnetic axes are not parallel to the Sun's, causing electromagnetic induction through the angular precession. The P subshell electron pairs fills the shell with unpaired electrons first, which are parallel, though their orbitals exist in three dimensions. For this reason, the circular electric field vectors, and electromagnetic fields of the array, may point their electromagnetic axes along the Suns's electromagnetic field lines; or they may point their dimensional directions relative to the heliospheric current sheet, and the Sun's electromagnetic field lines.

An alternate arrangement proposes alignment of the electromagnetic axes, where the rotational axes of the array are not aligned in the same direction. An additional alternate configuration relies on neither the magnetic or rotational axes being parallel to the Sun's electromagnetic axis. The purpose of these arrangements is to encourage magnetic reconnection, arranging energy levels in a such a manner that creates a probability field, that encourages quarks in the interplanetary magnetic field to form into the designed element.

The magnetic fields may further encourage fusion through the Sun's magnetic field, by projecting circularly or linearly polarized light on opposite sides of the heliosphere, where the Sun's magnetic field lines are separated by the heliospheric current sheet, so that the pairs of circularly or linearly polarized electromagnetic radiation that represent paired electrons, point in opposite directions at the Lagrange point. The projected light may utilize the absorption or emission spectrum of the element with the desired electron shell configuration for the fusion projection. The same method may be used to encourage quark fusion into elements, compounds, on the galactic current sheet, where gravitational bodies effect their Lagrange gravitational field on regions of the interstellar medium.

This method may also be utilized between the Lagrange of Jupiter's orbit with the Sun, Jupiter and Mars, or other gravitational bodies that have Lagrange points in their orbit, as well as around a singular celestial body, where the Lagrange Points are arranged to grow or create a new celestial body that has less than sufficient mass to generate Lagrange Gravitational Orbit Points.

1. Process to terraform atmosphere comprised of steps
a. Project circularly, or linearly polarized light, at Lagrange Points for planet in relation to its gravitational orbit around the Sun
b. Where there are one or two projections of electromagnetic radiation, light, at each Lagrange, mimicking opposite spin electrons in an orbital subshell,
c. The electromagnetic projection pair within the same Lagrange point has circular polarization, or spin, that is opposite the alternate electromagnetic projection at that specific Lagrange
d. Such that the circular polarized, or linearly polarized light, projects circular or linear electric field vectors, along or across the Sun's electromagnetic field lines
e. Creating an energy shell, emerging from the Lagrange points, which mimics the electron shell configuration of elements desired in the terraforming candidates atmosphere

2. Process to terraform atmosphere comprised of steps
a. Place artificial electromagnetic array at Lagrange Points for planet in relation to its gravitational orbit around the Sun
b. Where there are one or two electromagnetic fields at each Lagrange, mimicking opposite spin electrons in an orbital subshell
c. The electromagnetic fields within the same Lagrange point have rotation, or orientation, that are opposite to one another

3. Process to terraform atmosphere comprised of steps
a. Place artificial electromagnetic array at Lagrange Points for planet in relation to its gravitational orbit around the Sun
b. Where there are one or two electromagnetic fields at each Lagrange, mimicking opposite spin electrons in an orbital subshell
c. The electromagnetic fields within the same Lagrange point have alignment with Sun's electromagnetic field
